(19) United States
(12) Patent Application Publication
(10) Pub. No.: US 2006/0145654 A1
(43) Pub. Date: Jul. 6, 2006

(54) System and method for charging liftgate batteries

(76) Inventor: Robert Douglas, Shillington, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/030,684

(22) Filed: Jan. 6, 2005

(51) Int. Cl. H02J 7/00

(52) U.S. Cl. 320/104

(57) ABSTRACT

A system and method are disclosed for charging the liftgate batteries on a trailer having a trailer electrical system such as a refrigeration unit, from the charging system for the trailer electrical system. The system and method include an electrical connection between the liftgate batteries and the trailer electrical system alternator, wherein the trailer electrical system alternator has current capacity sufficient to power the trailer electrical system and to charge the liftgate batteries and the refrigeration unit battery; and an electrical isolation circuit for isolating the liftgate batteries from the trailer electrical system battery to prevent current from flowing from the trailer electrical system battery to the liftgate batteries.

### FIELD OF THE INVENTION

The present invention relates to a system and method for charging the liftgate batteries on a trailer that has an existing electrical charging system that is independent from the tractor's charging system.

### BACKGROUND OF THE INVENTION

In the United States, tractor trailers are the primary means by which goods are transported and distributed throughout the country. For example, tractor trailers with refrigeration units are used to transport perishable goods such as fruit, vegetables, meats, dairy products, beverages, plants, flowers, and any other good that needs to maintained at a certain temperature during transport.

To assist with the transport of goods by tractor trailer, trailers are usually equipped with electrically-powered liftgates. The liftgates greatly simplify the loading and unloading of trailers, alleviating the need to have workers climb in and out of the trailer and eliminating the need to use ramps to load and unload the trailer. The use of electrically-powered liftgates allows for shorter loading and unloading times, which greatly increases the efficiency of the tractor trailer distribution system in the United States. In a system in which tractor trailers travel millions of miles each year and in which drivers are under intense pressure to meet delivery deadlines, particularly when transporting perishable goods, the shorter loading and unloading times made possible by the use of electrically-powered liftgates is invaluable.

Unfortunately, the benefits gained by the use of electrically-powered liftgates are greatly offset by the current prior art methods used to charge the batteries used for the liftgates. The electrically-powered liftgate is powered by an electric motor that is connected to liftgate batteries which power the motor. In prior art liftgate systems, the liftgate batteries do not have their own charging system, thus in order to charge the batteries an outside power source must be connected to the batteries. The current prior art power source used to charge the liftgate batteries is the engine of the tractor used to pull the trailer. Typically, the tractor is left running at idle, and an electrical power cord is run from the tractor engine's electrical system to the liftgate batteries. This method of charging the liftgate batteries is extremely inefficient as enormous amounts of fuel are wasted when a tractor's massive engine, which is designed to pull a trailer weighing several tons, is used to charge liftgate batteries. Thus, the prior art method of charging the liftgate batteries is inefficient, and furthermore it is not usable if the trailer is no longer connected to the tractor.

It is therefore a principal object of this invention to provide a system and method for charging the liftgate batteries on a trailer that does not use a tractor's engine to charge the batteries.

It is a further object of this invention to provide a system and method for charging the liftgate batteries on a trailer that is energy efficient.

It is another object of this invention to provide a system and method for charging the liftgate batteries that can operate when the trailer is not connected to the tractor.

Further scope of the applicability of the present invention will become apparent from the detailed description given hereafter. However, it should be understood that the detailed description and specific examples, while indicating the preferred embodiments of the invention, are given as illustration, since various changes and modifications within the spirit and scope of the invention will become apparent to those skilled in the art from this detailed description.

### SUMMARY OF THE INVENTION

The current invention provides a method and system for charging the liftgate batteries on a trailer that has an existing electrical charging system that is independent from the charging system for the tractor. An example of a trailer that has an existing charging system that is independent from the charging system for the tractor is a refrigerated trailer. In the preferred embodiment of the invention, an electrical connection is added between the liftgate batteries and the alternator for the refrigeration system. In addition, an electrical isolation unit is placed in the system to electrically isolate the battery for the refrigeration system from the liftgate battery. The alternator is sized such that it has sufficient electrical capacity to power the refrigeration system (or other existing trailer system) and charge the generator batteries for the refrigeration unit (or other existing trailer system) and the liftgate batteries. The liftgate batteries are quick charging batteries such as glass absorption mat type batteries. In one embodiment, the battery for the refrigeration unit is electrically isolated from the liftgate batteries using a diode. In another embodiment, the battery for the refrigeration unit is electrically isolated from the liftgate batteries using a relay circuit.

### BRIEF DESCRIPTION OF THE DRAWINGS

FIG. 1 is a diagram of the system and method of the invention.

FIG. 2 is a diagram of another embodiment of the system and method of the invention.

FIG. 3 is a drawing of the prior method for charging a trailer's liftgate batteries.

### DETAILED DESCRIPTION OF THE INVENTION

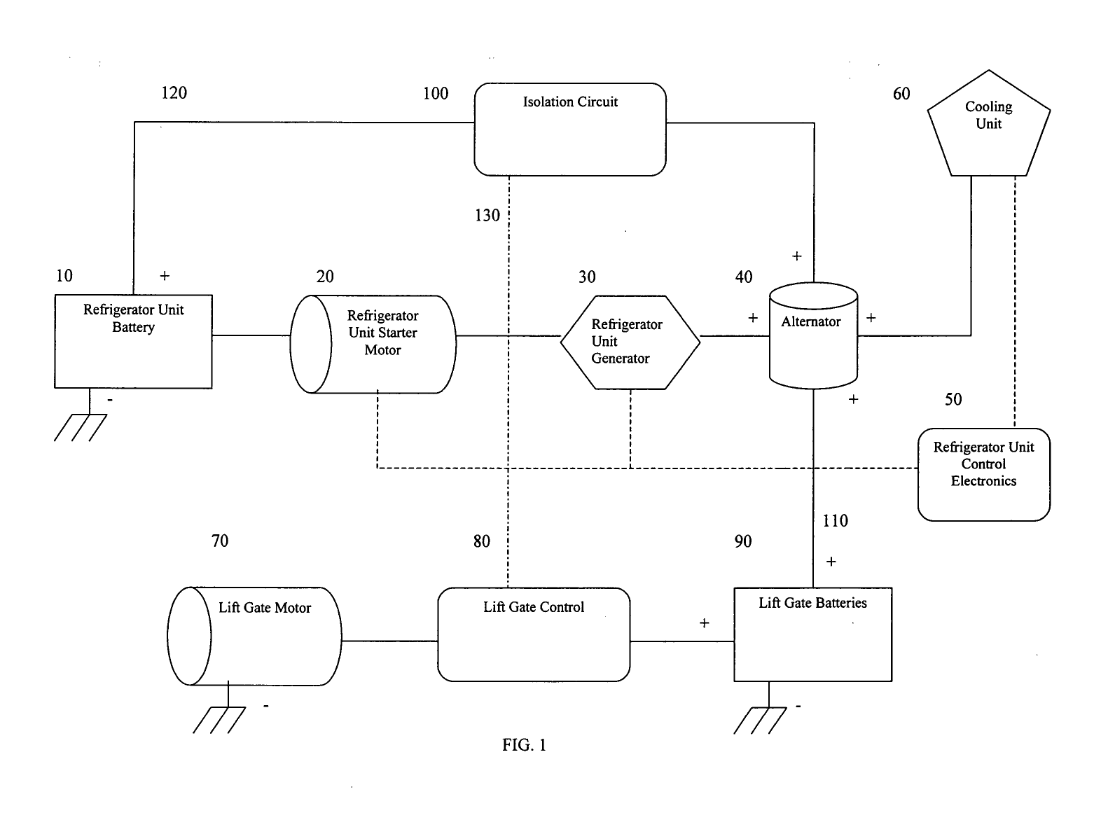

The following description of the embodiment of the present invention is shown in FIG. 1.

FIG. 1 shows a schematic diagram of the invention used with a trailer having an existing refrigeration system which has its own charging system that is independent from the tractor's charging system. Broadly speaking, the major components of the refrigeration unit are a diesel-fuel powered generator 30, an alternator 40, and an electrically-powered cooling unit 60. The diesel-fuel powered generator 30 is mechanically connected to the alternator 40, which converts the mechanical energy of the generator into electricity which is used to power the cooling unit. The electricity generated by the alternator 40 is transferred to the cooling unit 60 via electrical wiring.

The refrigeration unit also includes control electronics 50, batteries 10, and a starter motor 20 for the generator 30. The control electronics 50 include a thermostat which can be set to the temperature desired in the trailer. If the thermostat temperature is not met, the control electronics 50 cause an electrical connection to be made between the starter motor 20 and the batteries 10. The batteries 10 activate the starter motor 20, which in turn causes the generator 30 to run. Once the generator 30 is running, the control electronics 50 cause the starter motor to be deactivated. The generator 30 then causes the alternator 40 to produce electricity for the cooling unit 60. When the cooling unit 60 receives electricity it cools the trailer. Once the desired temperature in the trailer has been reached, an electrical switch in the control electronics 50 shuts off the generator. As will be understood by one skilled in the art, the refrigeration unit and the control electronics in particular may include switches, relays, solenoids, and/or other electronics well known in the art for controlling tractor refrigeration systems. As will be further understood by one skilled in the art, the control electronics are electrically connected to the various electrical components of the refrigeration unit as necessary to provide control over the components.

Importantly, in addition to providing power to the cooling unit, the alternator also charges the batteries for the generator 10, which are at least partially drained when they are used to power the starter motor. In the preferred embodiment of the invention, an electrical connection 110 is added between alternator 40 and the liftgate batteries 90 so that the alternator charges the liftgate batteries 90 as well as the batteries for the generator 10 when the alternator 40 is active. In addition, in one embodiment an electrical isolation circuit 100 is placed in the electrical connection 120 between the alternator 40 and the batteries for the generator 10. The isolation circuit 100 is designed to prevent current from flowing from the generator batteries 10 to the liftgate batteries 90. Without this circuit, the generator batteries 10 would be drained whenever the liftgate batteries 90 are used, because the generator batteries 10 and the liftgate batteries 90 are electrically connected through the alternator 40. In one embodiment, the electrical isolation circuit 100 can be a diode, an electrical element that only allows current to flow in one direction. In an alternative embodiment the electrical isolation circuit 100 can be a relay placed within the electrical connection between the alternator and the batteries for the generator. The relay can be electrically connected to the liftgate control circuitry 80 so that when the liftgate switches or buttons are operated, the relay is opened, which prevents any current from flowing from the generator batteries 10 to the liftgate system via the alternator 40. Other embodiments of electrical elements that isolate the generator batteries from the liftgate batteries can also be used.

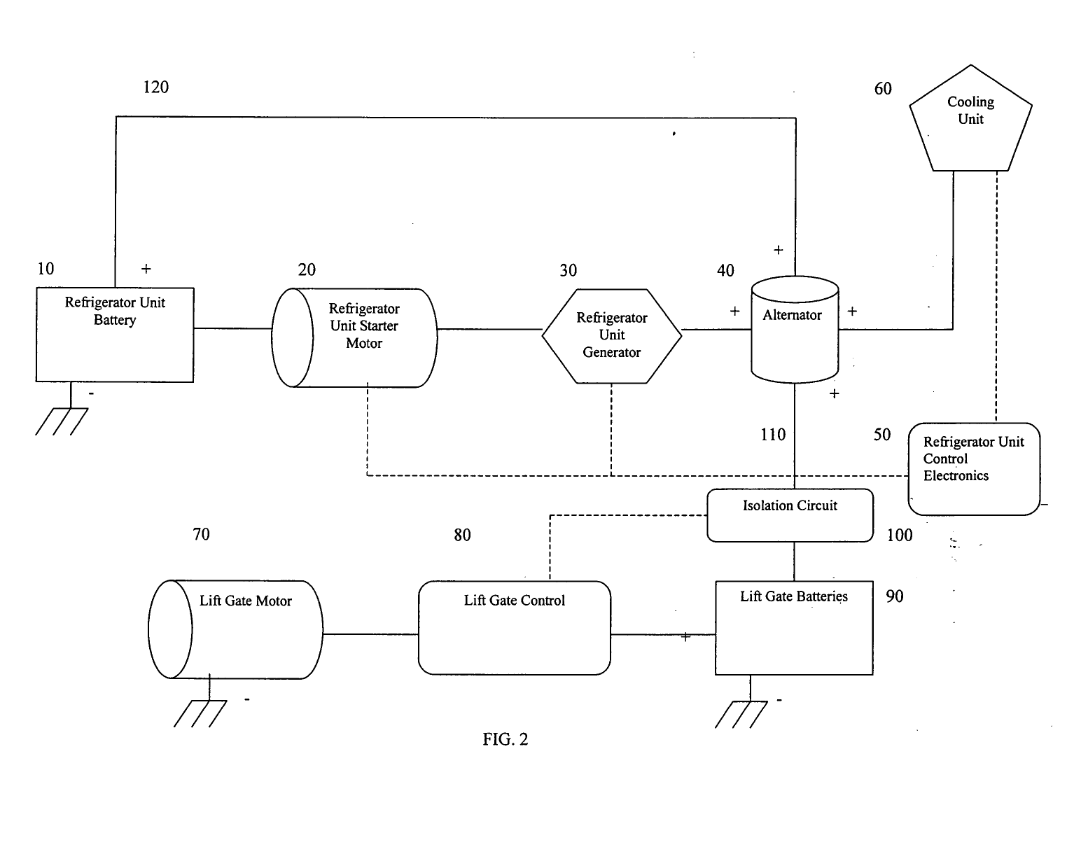

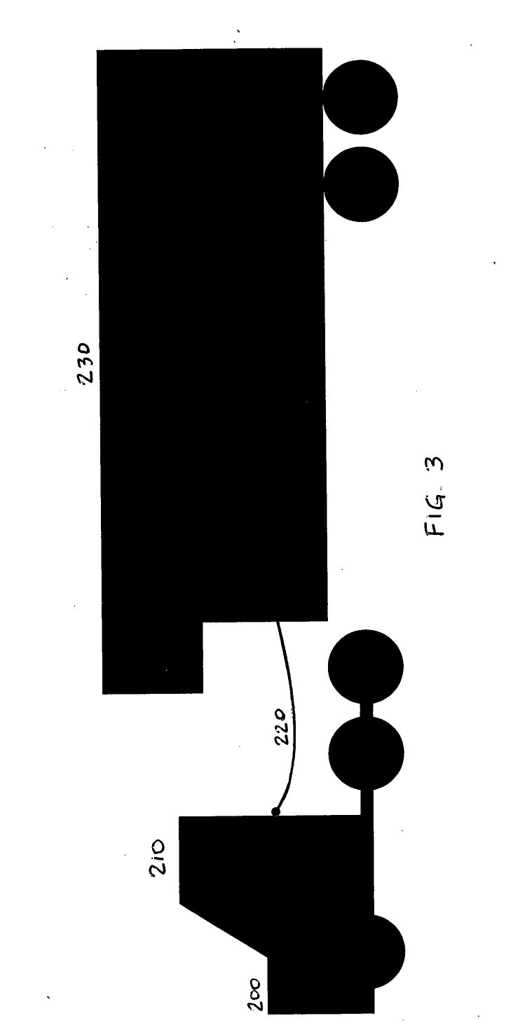

In the embodiment shown in FIG. 3, the electrical isolation unit 100 is placed within the electrical connection between the liftgate batteries 90 and the alternator 40. This embodiment also prevents current from flowing from the generator batteries 10 to the liftgate batteries 90. As with the embodiment of FIG. 2, the electrical isolation unit 100 can be a diode, an electrical element that only allows current to flow in one direction. In an alternative embodiment the electrical isolation unit can be a relay. The relay can be electrically connected 130 to the liftgate control circuitry 80 so that when the liftgate switches or buttons are operated, the relay is opened, which prevents any current from flowing from the generator batteries 10 to the liftgate system via the alternator 40. Other embodiments of electrical elements that isolate the generator batteries from the liftgate batteries can also be used.

Also in the preferred embodiment, the size of the alternator must be of an appropriate size to handle the load of the refrigeration unit, and load necessary to charge the liftgate batteries and the generator batteries. Existing alternator on refrigeration units are approximately rated at 37 amperes. In field testing, it was determined that increasing the alternator size to 65 amperes resulted in a system capable of powering the cooling unit and charging both the generator batteries and the liftgate batteries.

In addition to increasing the size of the generator alternator, in the preferred embodiment of the invention the liftgate batteries are absorption glass mat (AGM) type batteries. AGM batteries are preferred because they have a longer operating life and recharge more quickly than standard lead acid batteries. However, any battery may be used with the invention, although batteries with longer operating life and which recharge quickly are preferred.

In extensive field testing of the method and system of the invention over a 90 day period, the system and method of the invention resulted in significant fuel savings because the tractors that, under the prior art method of charging the liftgate batteries, previously were required to idle while the liftgate batteries were charging, no longer had to do so. Specifically, as a result of reduced idle time caused by the use of the system and method of the invention, each of the tractors in the pilot program averaged a idle time reduction of over 50%, and a reduction of idle fuel consumption of more than 170 gallons per tractor over a 90 day period. The results of the testing are shown in Table 1.

TABLE 1
Effect of Reduced Idle time on Fuel Consumption

| | Time in | Idle | Idle fuel | Idle fuel saved |
|---|---|---|---|---|
| | Idle (% | shutdown | used | per month |
| | of total | setting | (median | (median |
| Month | run time) | (minutes) | gallons) | gallons) |
| December | 37.2 | 60 | 100.1 | n/a |
| (baseline) | | | | |
| January | 17.4 | 5 | 28.1 | 72 |
| February | 18.0 | 5 | 35 | 64.8 |
| March | 26.9 | 15 | 62.7 | 37.4 |

Obviously, the fuel savings obtained using the invention is significant, particularly when such savings are applied to the tens of thousands of refrigeration trailers that currently use the prior art method of charging the liftgate batteries. As shown in Table 1, the savings obtained differ according to the idle time limit that was placed on the vehicles being tested. In December, an idle time limit of 60 minutes was placed on the test vehicles. This configuration was intended to simulate conditions before use of the invention, as it was assumed that tractors were rarely left to idle for more than 60 minutes at a time. As expected, when an idle time limit of 5 minutes was placed on the vehicles (i.e., the vehicles are permitted to idle no more than 5 minutes at a time), significant fuel savings were obtained. In addition, significant fuel savings were obtained when an idle limit time of 15 minutes was used, albeit less than the savings obtained when using a 5 minute idle limit time. Significantly, these reductions in idle time did not affect the availability of the liftgates, because the invention eliminated the need for idle time to charge the liftgate batteries.

Significantly, the field testing also revealed that the refrigeration units (and hence the fuel-powered generators for the refrigeration units) did not experience an increase in usage during the testing, even though under the system and method of the invention the refrigeration units had the added task of charging the liftgate batteries as well powering the refrigeration unit and charging the generator batteries. Specifically, maintenance records indicated that before the testing, the refrigeration units averaged 449 running hours per month. After the system and method was added to the units, the refrigeration units averaged a run time of 372 hours per month. The reduction of hours after the invention was fitted is deemed to be statistically insignificant, and may be due to differences in ambient temperature or product volumes. The lack of a statistically significant difference between the run time hours of the refrigeration unit before and after the invention was fitted to the test units indicates that the savings realized by the reduced idle time of the tractors is fully realized and not offset by increased fuel usage by the refrigerator generator.

FIG. 3 shows the prior art method of charging the liftgate batteries on a refrigerated trailer. In the prior art charging system, the engine 200 of the tractor 210 used to pull the trailer 230 is used to recharge the liftgate batteries. Typically, the tractor 210 is left running at idle, and an electrical power cord 220 is run from the tractor engine's electrical system to the liftgate batteries in the trailer 230. This method of charging the liftgate batteries is extremely inefficient and furthermore it is not usable if the trailer is no longer connected to the tractor.

Although the invention has been described in terms of various specific embodiments, those skilled in the art will recognize that the invention can be practiced with modification within the spirit and scope of the claims. For example, those skilled in the art will recognize that the invention can be practiced with any trailer that has a charging system that is independent from the charging system for the tractor, including, but not limited to, trailers with refrigeration units that have their own charging system.

What is claimed is:

1. A system for charging the liftgate batteries on a trailer having an electrically powered liftgate and a trailer electrical system having a trailer electrical system battery electrically connected to the output of a trailer electrical system alternator, comprising:
an electrical connection between the liftgate batteries and the trailer electrical system alternator, wherein said alternator has current capacity sufficient to power the existing trailer system and to charge the liftgate batteries and the trailer electrical system battery; and
an electrical isolation circuit for isolating the liftgate batteries from the trailer electrical system battery to prevent current from flowing from the trailer electrical system battery to the liftgate batteries.

2. The system of claim 1 wherein said liftgate batteries are glass absorption mat type batteries.

3. The system of claim 1 wherein the electrical connection between the liftgate batteries and the trailer electrical system alternator comprises appropriate size electrical wiring.

4. The system of claim 1 wherein said electrical isolation circuit comprises a diode in the electrical connection between the trailer electrical system battery and the output of the trailer electrical system alternator.

5. The charging system of claim 1 wherein said electrical isolation circuit comprises a relay in the electrical connection between the trailer electrical system battery and the output of the trailer electrical system alternator, wherein said relay is electrically connected to the control panel for the liftgate such that said relay is caused to open when said liftgate is in operation.

6. The system of claim 1 wherein said electrical isolation circuit comprises a diode in the electrical connection between the liftgate battery and the output of the trailer electrical system alternator.

7. The charging system of claim 1 wherein said electrical isolation circuit comprises a relay in the electrical connection between the liftgate battery and the output of the trailer electrical system alternator, wherein said relay is electrically connected to the control panel for the liftgate such that said relay is caused to open when said liftgate is in operation.

8. A system for charging the liftgate batteries on a trailer having an electrically powered liftgate and a refrigeration unit having a refrigeration unit battery electrically connected to the output of a refrigeration unit alternator comprising:
an electrical connection between the liftgate batteries and the output of the refrigeration unit alternator, wherein the refrigeration unit alternator has current capacity sufficient to power the refrigeration unit and to charge the liftgate batteries and the refrigeration unit battery;
an electrical isolation circuit for isolating the liftgate batteries from the refrigeration unit battery to prevent current from flowing from the refrigeration unit battery to the liftgate batteries.

9. The system of claim 8 wherein said liftgate batteries are glass absorption mat type batteries.

10. The system of claim 8 wherein the electrical connection between said the liftgate batteries and the output of the refrigeration unit alternator comprises appropriate size electrical wiring.

11. The system of claim 8 wherein said electrical isolation circuit comprises a diode in the electrical connection between the refrigeration unit battery and the output of the refrigeration unit alternator.

12. The system of claim 8 wherein said electrical isolation circuit comprises a relay in the electrical connection between the refrigeration unit battery and the output of the refrigeration unit alternator, wherein said relay is electrically connected to the control panel for the liftgate such that said relay is caused to open when said liftgate is in operation.

13. The system of claim 8 wherein said electrical isolation circuit comprises a diode in the electrical connection between the liftgate battery and the output of the refrigeration unit alternator.

14. The system of claim 8 wherein said electrical isolation circuit comprises a relay in the electrical connection between the liftgate battery and the output of the refrigeration unit alternator, wherein said relay is electrically connected to the control panel for the liftgate such that said relay is caused to open when said liftgate is in operation.

15. A method for upgrading the charging system for the liftgate batteries on a trailer having an electrically powered liftgate and a refrigeration unit having a refrigeration unit battery electrically connected to the output of a refrigeration unit alternator comprising:
upgrading the existing refrigeration unit alternator with a larger capacity alternator having current capacity sufficient to power the refrigeration unit and to charge the liftgate-batteries and the refrigeration unit battery;
electrically connecting the liftgate batteries to the output of the upgraded refrigeration unit alternator;
electrically isolating the liftgate batteries from the refrigeration unit battery to prevent current from flowing from the refrigeration unit battery to the liftgate batteries.

16. The method of claim 15 further comprising upgrading each of the existing liftgate batteries with an absorption glass mat type battery.

17. The system of claim 15 wherein electrically connecting the liftgate batteries to the upgraded refrigeration unit alternator comprises electrically connecting the upgraded liftgate batteries to the electrical output of the upgraded refrigeration unit alternator with appropriate size electrical wiring.

18. The system of claim 15 wherein electrically isolating the liftgate batteries from the refrigeration unit battery comprises installing a diode in the electrical connection between the refrigeration unit battery and the output of the upgraded refrigeration unit alternator.

19. The system of claim 15 wherein electrically isolating the liftgate batteries from the refrigeration unit battery comprises installing a relay in the electrical connection between the refrigeration unit battery and the output of the upgraded refrigeration unit alternator, said relay being electrically connected to the control panel for the liftgate such that said relay is caused to open when said liftgate is in operation.

20. The system of claim 15 wherein electrically isolating the liftgate batteries from the refrigeration unit battery comprises installing a diode in the electrical connection between the liftgate battery and the output of the upgraded refrigeration unit alternator.

21. The system of claim 15 wherein electrically isolating the liftgate batteries from the refrigeration unit battery comprises installing a relay in the electrical connection between the liftgate battery and the output of the upgraded refrigeration unit alternator, said relay being electrically connected to the control panel for the liftgate such that said relay is caused to open when said liftgate is in operation.
